(19) United States
(12) Patent Application Publication
(10) Pub. No.: US 2013/0182198 A1
(43) Pub. Date: Jul. 18, 2013

(54) Backlight display Module and Liquid Crystal Display Device

(71) Applicants: Kuangyao Chang, Shenzhen (CN); Jianfa Huang, Shenzhen (CN)

(72) Inventors: Kuangyao Chang, Shenzhen (CN); Jianfa Huang, Shenzhen (CN)

(73) Assignee: Shenzhen China Star Optoelectronics Technology Co. Ltd., Guangdong (CN)

(21) Appl. No.: 13/264,556

(22) PCT Filed: Jun. 21, 2011
(86) PCT No.: PCT/CN11/76078

§ 371 Date: Oct. 14, 2011

(30) Foreign Application Priority Data
Jun. 13, 2011 (CN) 201110157692.7

(51) Int. Cl. G02F 1/1335

(52) U.S. Cl. CPC G02F 1/133615
USPC 349/58

(57) ABSTRACT

The present invention provides a backlight display module. The backlight display module has a light source used to emit lights; a light guide plate used to receive the lights and distribute the lights out of a light-emitting surface; a liquid crystal panel disposed on a top of the light-emitting surface of the light guide plate and used to display images; and a metal frame disposed at a periphery of the backlight display module and used to fix the liquid crystal panel to a corresponding position to the light guide plate. The backlight display module further has a light absorption layer mounted between the liquid crystal panel and the metal frame. The present invention further relates to a liquid crystal display device. The backlight display module and the liquid crystal display device of the present invention use the light absorption layer to prevent high-brightness light spots from forming at the periphery of the liquid crystal panel.

### FIELD OF THE INVENTION

The present invention relates to a backlight display field, and more particularly to a backlight display module and liquid crystal display device that avoid light spots forming at side surfaces.

### BACKGROUND OF THE INVENTION

With the development of technology, liquid crystal display devices are massively used in every display field, such as mobile phones, computer monitors, and are well liked by users due to good features of lightweight, small size and low power-consuming. And a backlight display module is one of the most important components that achieve the display function of a liquid crystal display device.

In an integrated backlight display module, since a frame thereof is made of metal, such as stainless steel, and has a high reflectivity. Without appropriate treatment, bright light spots may easily appear in side edges of the backlight display module and severely affect the display quality. With reference to FIG. 1, a metal frame 101 of a backlight display module 100 tightly compacts a liquid crystal panel 102 and an optical film 103. Since the metal frame 101 has higher reflectivity, therefore lights emitted by a light source 105 through a light guide plate 104 may be easily reflected by the metal frame 101 and travel out of the side edges of the liquid crystal panel 102, and thereby cause the backlight display module 100 to have high-brightness light spots on the side edges thereof.

Hence, it is necessary to provide a backlight display module and liquid crystal display device to overcome the problems existing in the conventional technology.

### SUMMARY OF THE INVENTION

An object of the invention is to provide a backlight display module and a liquid crystal display device to overcome a problem that high-brightness light spots are easily formed on side edges of a liquid crystal panel and affects display quality due to a reflection of metal frame when using conventional backlight display module and liquid crystal display device.

The present invention is implemented as follows:

A backlight display module having a light source used to emit lights; a light guide plate used to receive the lights and distribute the lights out of a light-emitting surface thereof; a liquid crystal panel disposed on a top of the light-emitting surface of the light guide plate and used to display images; and a metal frame disposed at a periphery of the backlight display module and used to fix the liquid crystal panel to a corresponding position to the light guide plate, wherein the backlight display module further has a light absorption layer mounted between the liquid crystal panel and the metal frame; the light absorption layer is a black buffer film attached to an inner surface of the metal frame, a blackening layer formed on the inner surface of the metal frame through blacken treatment or a black adhesion layer attached on a periphery of the liquid crystal panel; and the light absorption layer is disposed outside an effective display area of the backlight display module.

The present invention further provides a backlight display module having a light source used to emit lights; a light guide plate used to receive the lights and distribute the lights out of a light-emitting surface thereof; a liquid crystal panel disposed on a top of the light-emitting surface of the light guide plate and used to display images; and a metal frame disposed at a periphery of the backlight display module and used to fix the liquid crystal panel to a corresponding position to the light guide plate, wherein the backlight display module further has a light absorption layer mounted between the liquid crystal panel and the metal frame.

The present invention further provides a liquid crystal display device having a backlight display module having

In one embodiment of the present invention, the a light source used to emit lights; a light guide plate used to receive the lights and distribute the lights out of a light-emitting surface thereof; a liquid crystal panel disposed on a top of the light-emitting surface of the light guide plate and used to display images; and a metal frame disposed at a periphery of the backlight display module and used to fix the liquid crystal panel to a corresponding position to the light guide plate, wherein the backlight display module further has a light absorption layer mounted between the liquid crystal panel and the metal frame.

In one embodiment of the present invention, the light absorption layer is a back buffer film attached to an inner surface of the metal frame.

In one embodiment of the present invention, the black buffer film is a back rubber film or a black polyester film.

In one embodiment of the present invention, the light absorption layer is a blackening layer formed on an inner surface of the metal frame through blacken treatment.

In one embodiment of the present invention, the light absorption layer is a black adhesion layer attached on a periphery of the liquid crystal panel.

In one embodiment of the present invention, the backlight display module further has an optical film disposed between the liquid crystal panel and the light guide plate, and the optical film is fixed on a lower surface of the liquid crystal panel via the black adhesion layer.

In one embodiment of the present invention, the black adhesion layer is a black adhesive tape.

In one embodiment of the present invention, the light absorption layer is disposed outside an effective display area of the backlight display module.

Comparing with the conventional backlight display module and liquid crystal display device having a problem that high-brightness light spots are easily formed on side edges of a liquid crystal panel and affects display quality due to a reflection of metal frame when being used, the backlight display module and the liquid crystal display device of the present invention prevents high-brightness light spots from being formed at side edges of a liquid crystal panel thereof by disposing a light absorption layer, so as to enhance the display quality of a display panel.

In order to make the contents of the present invention to be easily understood, below, the preferred embodiments of the present invention are described in detail in cooperation with accompanying drawings as follows:

### DESCRIPTION OF THE DRAWINGS

FIG. 1 is a structural schematic view of a backlight display module in accordance with the prior art;

FIG. 2 is a structural schematic view of a first embodiment of a backlight display module in accordance with the present invention;

FIG. 3 is a structural schematic view of a second embodiment of a backlight display module in accordance with the present invention;

FIG. 4 is a structural schematic view of a third embodiment of a backlight display module in accordance with the present invention; and

FIG. 5 is a structural schematic view of a fourth embodiment of a backlight display module in accordance with the present invention.

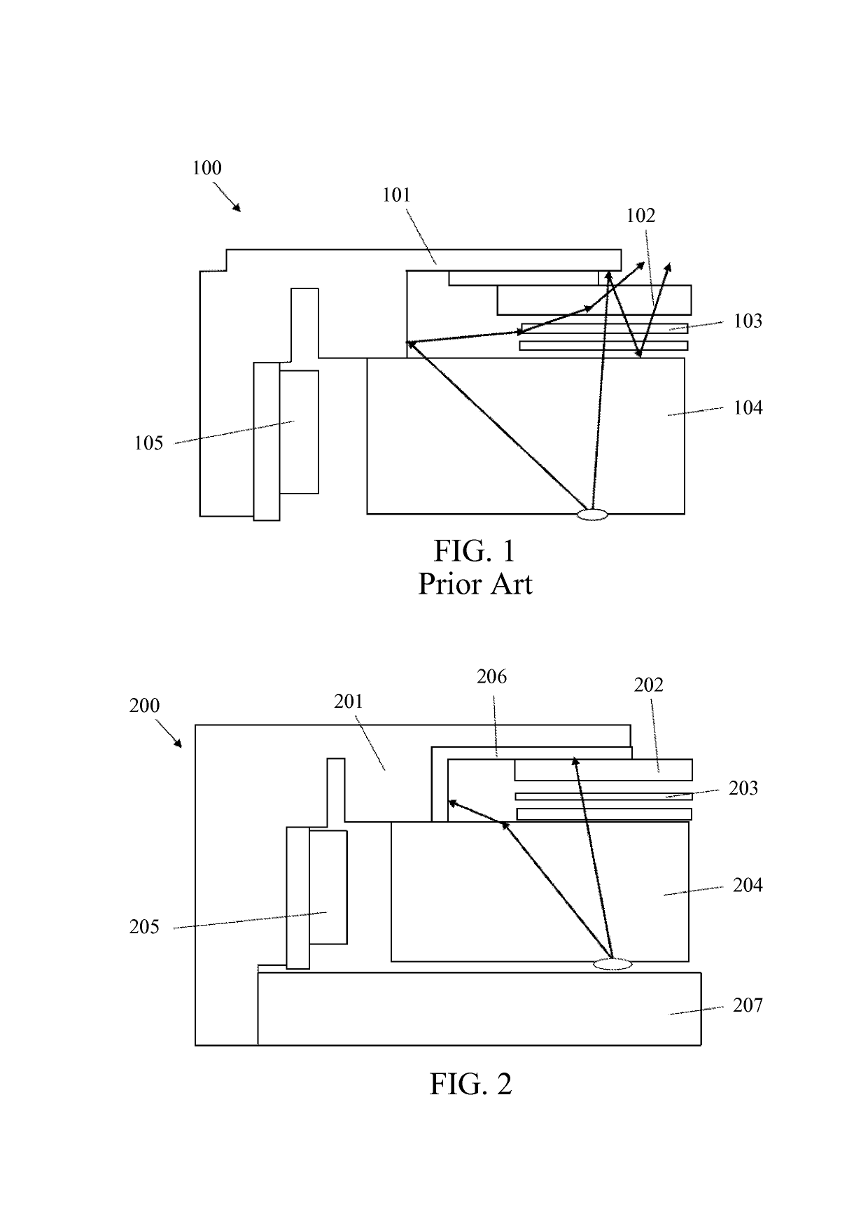

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

In the drawings, units with similar structure are labeled with the same reference number.

With reference to FIG. 2, a structural schematic view of a first embodiment of a backlight display module in accordance with the present invention, the backlight display module of the present invention is a side-light type backlight display module, and the backlight display module 200 comprises a light guide plate 204 and a light source 205. The light source 205 may be a light source such as a cold cathode fluorescent lamp, light emitting diodes, organic light emitting diodes, electro-luminescence, light bar or any combination thereof. The backlight display module 200 further has a liquid crystal panel 202, a metal frame 201 and a light absorption layer 206. The light guide plate 204 is used to receive lights and distribute the lights out of a light-emitting surface of the light guide plate 204; the liquid crystal panel 202 is disposed on a top of the light-emitting surface of the light guide plate 204 and is used to display images; the metal frame 201 is disposed at a periphery of the backlight display module 200 and used to fix the liquid crystal panel 202 to a corresponding position to the light guide plate; the light absorption layer 206 is mounted between the liquid crystal panel 202 and the metal frame 201, and is used to fully absorb the lights that are reflected by the light guide plate 204 to the metal frame 201, so as to prevent the surplus lights from travelling out of side edges of the liquid crystal panel 202 that leads to high-brightness light spot forming at the side edges of the backlight display module 200 and thereby affects display quality.

With reference to FIG. 2, in the first preferred embodiment of the backlight display module of the present invention, the light absorption layer 206 is a black buffer film attached to an inner surface of the metal frame 201, and the black buffer film may be a black rubber film or a black polyester film. When the backlight display module 200 is being used, the lights are emitted by the light source 205, travel into an incident surface of the light guide plate 204, the lights turn into diffusion lights through netted dots disposed on a bottom of the light guide plate 204 and travel out of a light-emitting surface of the light guide 204 and pass through an optical film 203 to form images on the liquid crystal panel 202, and the backlight display module 200 dissipates heat through a metal board 207 disposed at a bottom thereof.

The black buffer film attached between the inner surface of the metal frame 201 and the liquid crystal panel 202 not only effectively absorbs the scattered lights emitted from the light guide plate 204, but also provides a buffering effect between the liquid crystal panel 202 and the metal frame 201 so that the metal frame 201 would not cause damages to the liquid crystal panel 202. The means being adopted is simple and convenient, and is able to reconstruct existing backlight display module 200 immediately, which just need to detach the metal frame 201 from the backlight display module 200, and attach a black buffer film on a corresponding position thereto and then re-assemble the metal frame 201, and a treatment of preventing high-brightness light spots on side edges is accomplished. In the meantime, the light absorption layer 206 that is mounted between the liquid crystal panel 202 and the metal frame 201 does not make any influence to the light-emitting and light-receiving ability of the light guide plate 204, and is only to remove the redundant scattered lights on the side edges of the display panel.

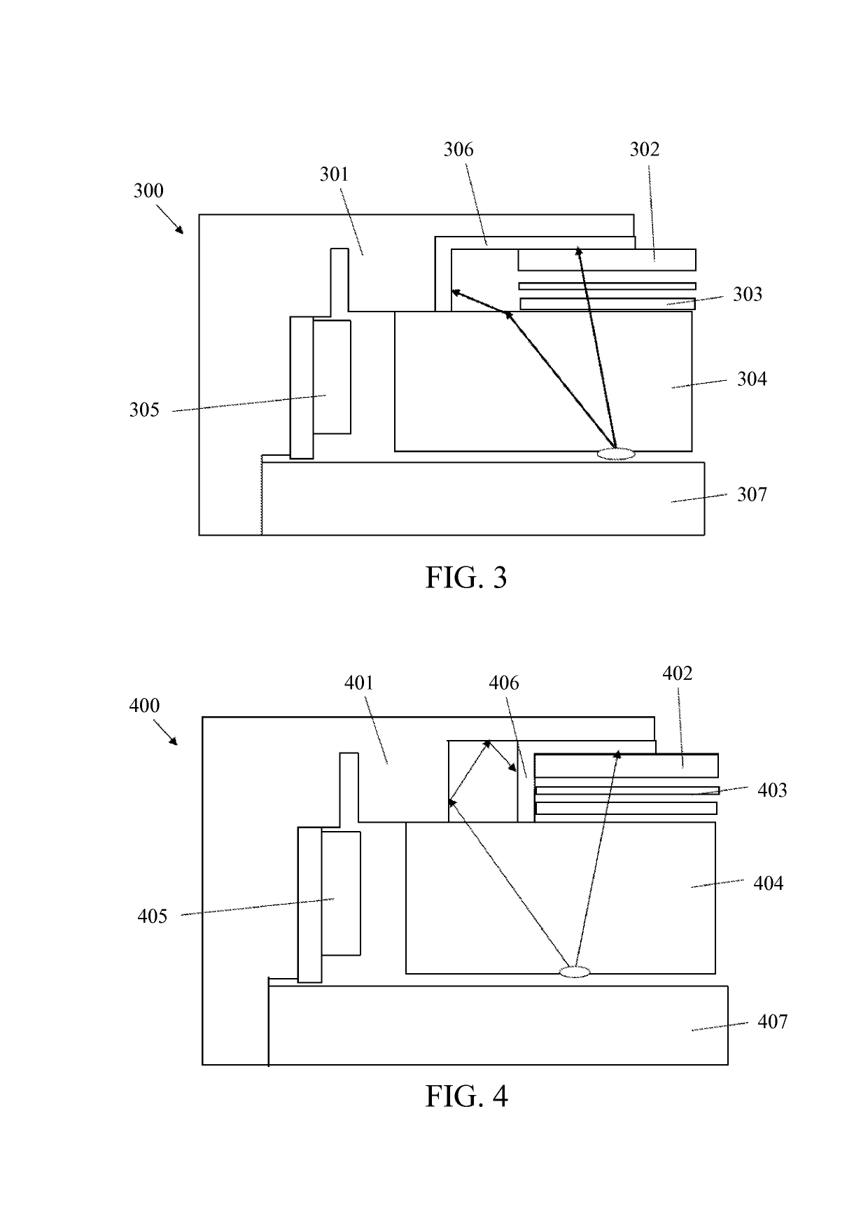

With reference to FIG. 3, in a second embodiment of the backlight display module of the present invention, the light absorption layer 306 is a blackening layer formed on the inner surface of the metal frame 301 through a blacken treatment. When the backlight display module 300 of this embodiment is being used, the lights are emitted by the light source 305, travel into the incident surface of the light guide plate 304, the lights then turn into diffusion lights through netted dots disposed on the bottom of the light guide plate 304 and travel out of the light-emitting surface of the light guide 304 and pass through the optical film 303 to form images on the liquid crystal panel 302, and the backlight display module 300 dissipates heat through a metal board 307 disposed at a bottom thereof.

By performing a blackening treatment on the inner surface of the metal frame 301, the scattering lights emitted from the light guide plate 304 can be effectively absorbed, and the structure of the entire backlight display module 300 is simple without any other additional structures and fully absorb the lights that are reflected by the light guide plate 304 to the metal frame 301, so as to prevent the surplus lights from travelling out of side edges of the liquid crystal panel 302 and affecting display quality. In the meantime, the light absorption layer 306 that is mounted between the liquid crystal panel 302 and the metal frame 301 does not make any influence to the light-emitting and light-receiving ability of the light guide plate 304, and is only to remove the redundant scattered lights on the side edges of the display panel.

With reference to FIG. 4, in a third embodiment of the backlight display module of the present invention, the light absorption layer 406 is a black adhesion layer attached on a periphery of the liquid crystal panel 402. The black adhesion layer is a black adhesive tape. When the backlight display module 400 of this embodiment is being used, the lights are emitted by the light source 405, travel into the incident surface of the light guide plate 404, the lights then turn into diffusion lights through netted dots disposed on the bottom of the light guide plate 404 and travel out of the light-emitting surface of the light guide 404 and finally pass through the optical film 403 to form images on the liquid crystal panel 402, and the backlight display module 400 dissipates heat through a metal board 407 disposed at a bottom thereof.

Attaching the black adhesion layer to the periphery of the liquid crystal panel 402 can also effectively absorb the scattered lights emitted from the light guide plate 404, wherein the black adhesion layer mounted at the periphery of the liquid crystal panel 404 also provides a great buffering effect between the liquid crystal panel 402 and the metal frame 401 so that the metal frame 401 would not cause damages to the liquid crystal panel 402. And the means being adopted is simple and convenient, and is able to reconstruct existing backlight display module 400 immediately, which just need to detach the metal frame 401 from the backlight display module 400, and attach the black adhesion layer on a corresponding position thereto and then re-assemble the metal frame 401, and a treatment of avoiding high-brightness light spots on side edges is accomplished. In the meantime, the light absorption layer 406 that is mounted between the liquid crystal panel 402 and the metal frame 401 does not make any influence to the light-emitting and light-receiving ability of the light guide plate 404, and is only to remove the redundant scattered lights on the side edges of the display panel.

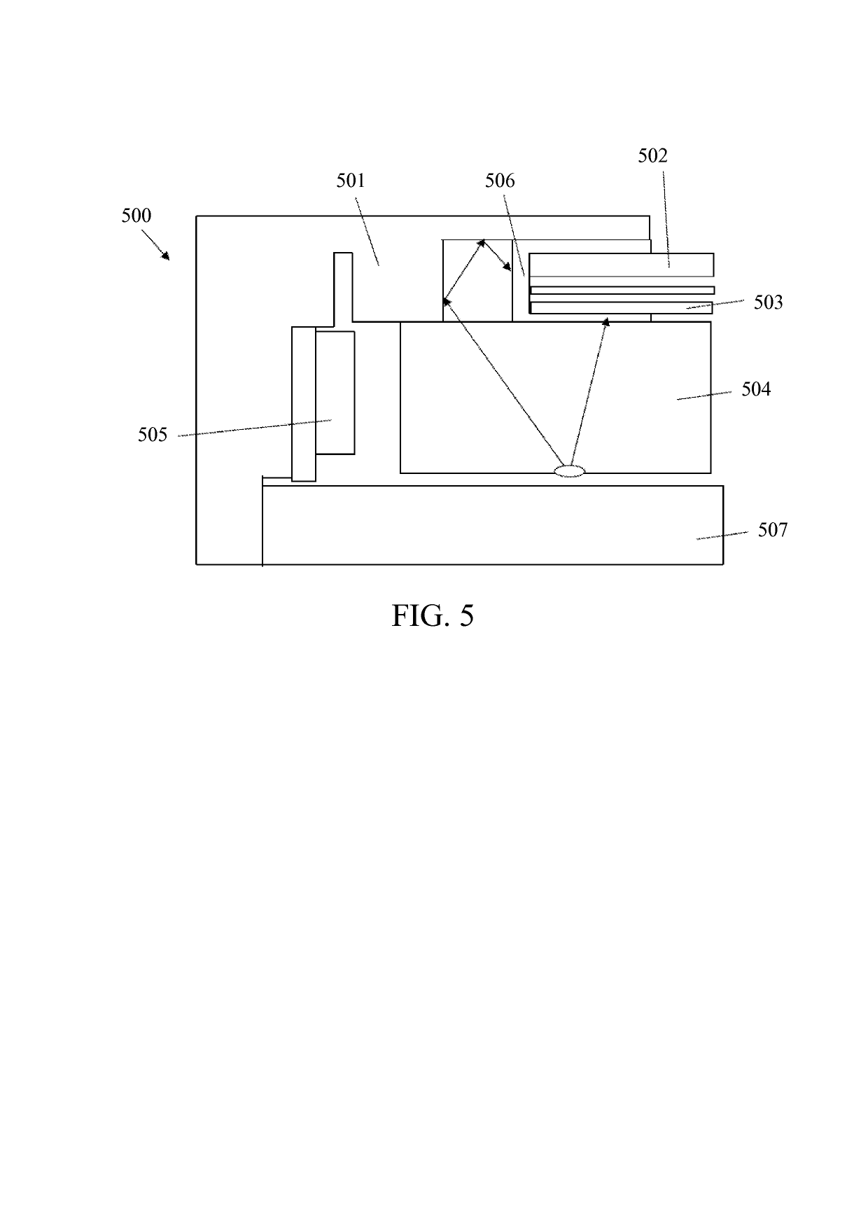

With reference to FIG. 5, in a fourth embodiment of the backlight display module of the present invention, an optical film 503 is fixed to a lower surface of the liquid crystal panel 502 via the black adhesion layer. When the backlight display module 500 of this embodiment is being used, the lights are emitted by the light source 505, travel into the incident surface of the light guide plate 504, the lights then turn into diffusion lights through netted dots disposed on the bottom of the light guide plate 504 and travel out of the light-emitting surface of the light guide 504 and finally pass through the optical film 503 to form images on the liquid crystal panel 502, and the backlight display module 500 dissipates heat through a metal board 507 disposed at a bottom thereof.

With the black adhesion layer fixing the optical film 503 to the lower surface of the liquid crystal panel 502, while effectively absorbing the scattered lights emitted from the light guide plate 504, the black adhesion layer can cover the side edges of the optical film 503 and the side edges of the liquid crystal panel 502 to accomplish fixing the optical film 503 and the liquid crystal panel 502, so that the optical film 503 does not slide relatively to the liquid crystal panel 502 and thereby ensures the display quality of the backlight display module 500. And adopting this means is simple and convenient, and is able to reconstruct existing backlight display module 500 immediately, which just need to detach the metal frame 501 from the backlight display module 500, and wrap the black adhesion layer on a corresponding position of the liquid crystal panel 502 and the optical film 503, and then re-assemble the metal frame 501, and a treatment of avoiding high-brightness light spots on side edges is then accomplished. In the meantime, the light absorption layer 506 that is mounted between the liquid crystal panel 502 and the metal frame 501 does not make any influence to the light-emitting and light-receiving ability of the light guide plate 504, and is only to remove the redundant scattered lights on the side edges of the display panel.

In the preferred embodiments of the backlight display module of the present invention, the light absorption layer is disposed outside an effective display area of the backlight display module. The display area of the backlight display module is divided into the effective display area and a visible area. The effective display area is the largest display area of the backlight display module, and the visible area is the actual display area of the backlight display module, the manufacturer may adopt different ranges of visible area according to requirements when practically producing products, but the visible area will never be larger than the effective display area. In order to let the light absorption layer not affect the display effect of the backlight display module and be able to meet the manufacturing requirements for every manufacturer, when designing, the light absorption layer will be disposed outside the effective display area of the backlight display module in advance, so that when the backlight display module is going through next step of design, no matter how lager the range of the visible area is, the light absorption layer will make no influence to the visible area and be able to accomplish the effect of avoiding high-brightness light spots at side edges of the display panel.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A backlight display module comprising:
a light source used to emit lights;
a light guide plate used to receive the lights and distribute the lights out of a light-emitting surface of the light guide plate;
a liquid crystal panel disposed on a top of the light-emitting surface of the light guide plate and used to display images; and
a metal frame disposed at a periphery of the backlight display module and used to fix the liquid crystal panel to a corresponding position to the light guide plate;
characterized in that:
the backlight display module further has a light absorption layer mounted between the liquid crystal panel and the metal frame;
the light absorption layer is a black buffer film attached to an inner surface of the metal frame, a blackening layer formed on the inner surface of the metal frame through blacken treatment or a black adhesion layer attached on a periphery of the liquid crystal panel; and
the light absorption layer is disposed outside an effective display area of the backlight display module.

2. A backlight display module comprising:
a light source used to emit lights;
a light guide plate used to receive the lights and distribute the lights out of a light-emitting surface of the light guide plate;
a liquid crystal panel disposed on a top of the light-emitting surface of the light guide plate and used to display images; and
a metal frame disposed at a periphery of the backlight display module and used to fix the liquid crystal panel to a corresponding position to the light guide plate;
characterized in that:
the backlight display module further has a light absorption layer mounted between the liquid crystal panel and the metal frame.

3. The backlight display module as claimed in claim 2, characterized in that: the light absorption layer is a back buffer film attached to an inner surface of the metal frame.

4. The backlight display module as claimed in claim 3, characterized in that: the black buffer film is a back rubber film or a black polyester film.

5. The backlight display module as claimed in claim 2, characterized in that: the light absorption layer is a blackening layer formed on an inner surface of the metal frame through blacken treatment.

6. The backlight display module as claimed in claim 2, characterized in that: the light absorption layer is a black adhesion layer attached on a periphery of the liquid crystal panel.

7. The backlight display module as claimed in claim 6, characterized in that: the backlight display module further has an optical film disposed between the liquid crystal panel and the light guide plate, and the optical film is fixed on a lower surface of the liquid crystal panel via the black adhesion layer.

8. The backlight display module as claimed in claim 7, characterized in that: the black adhesion layer is a black adhesive tape.

9. The backlight display module as claimed in claim 2, characterized in that: the light absorption layer is disposed outside an effective display area of the backlight display module.

10. A liquid crystal display device comprising:
a backlight display module having:
a light source used to emit lights;
a light guide plate used to receive the lights and distribute the lights out of a light-emitting surface of the light guide plate;
a liquid crystal panel disposed on a top of the light-emitting surface of the light guide plate and used to display images; and
a metal frame disposed at a periphery of the backlight display module and used to fix the liquid crystal panel to a corresponding position to the light guide plate;
characterized in that:
the backlight display module further has a light absorption layer mounted between the liquid crystal panel and the metal frame.

11. The liquid crystal display device as claimed in claim 10, characterized in that: the light absorption layer is a back buffer film attached to an inner surface of the metal frame.

12. The liquid crystal display device as claimed in claim 11, characterized in that: the black buffer film is a back rubber film or a black polyester film.

13. The liquid crystal display device as claimed in claim 10, characterized in that: the light absorption layer is a blackening layer formed on an inner surface of the metal frame through blacken treatment.

14. The liquid crystal display device as claimed in claim 10, characterized in that: the light absorption layer is a black adhesion layer attached on a periphery of the liquid crystal panel.

15. The liquid crystal display device as claimed in claim 14, characterized in that: the backlight display module further has an optical film disposed between the liquid crystal panel and the light guide plate, and the optical film is fixed on a lower surface of the liquid crystal panel via the black adhesion layer; and the black adhesion layer is a black adhesive tape.
